(19) United States
(12) Patent Application Publication
(10) Pub. No.: US 2009/0076767 A1
(43) Pub. Date: Mar. 19, 2009

(54) DEVICE FOR DETERMINING A NEUTRAL POSITION OF TWO COMPONENTS

(75) Inventors: Ulrich Mair, Friedrichshafen (DE); Karl-Hermann Ketteler, Markdorf (DE); Frank Gessler, Grunkraut (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/202,697

(22) Filed: Sep. 2, 2008

(30) Foreign Application Priority Data
Sep. 13, 2007 (DE) 10 2007 043 589.6

(51) Int. Cl. B62D 15/02

(52) U.S. Cl. 702/150

(57) ABSTRACT

A device for determining a neutral position of two components (1, 2) that are displaceable relative to one another, comprising an adjustment device for moving the components (1, 2) into any arbitrary relative position and a positional sensor (9) for detecting the relative position, as well as path marker (6) located on the first component (1) and a marker sensor (8) provided on the second component (2) to detect the path marker (6) in a detection region (7), characterized in that in the neutral position the components (1, 2) are aligned with each other in such a manner that the path marker (6) is arranged outside the detection region (7) of the marker sensor (8), wherein the distance (10) between the detection region (7) and the path marker (6) is known, and the device comprises a data processing installation that is linked to the marker sensor (8) and the positional sensor (9), said installation determining the neutral position, when there is detection of the path marker (6) by the marker sensor (8) on the basis of the relative position detected by the positional sensor (9) and the known distance (10) between the detection region (7) of the marker sensor (8) and the path marker (6).

This application claims priority from German Application Serial No. 10 2007 043 589.6 filed Sep. 13, 2007.

### FIELD OF THE INVENTION

The present invention relates to a device and a method of determining a neutral position of two components that are displaceable relative to one another according to the characteristics of the preamble of the respective claims.

### BACKGROUND OF THE INVENTION

In the automotive industry, electrically, hydraulically, or pneumatically operating actuators are employed for the defined movement of a plurality of systems, for example in securing the doors in a central locking system or adjusting the engine performance of speed controllers. In so doing, it is usually necessary for the actuators to assume defined positions and to perform defined movements, when in these positions, for which purpose they are equipped with positional sensors, such as displacement sensors and angle sensors, as well as stationary stops or path marks. They normally also comprise multiplication elements such as levers or gearboxes, because the motors used, due to the low onboard voltage and the limited amperage, can only produce low torque or forces. The positional sensors are hereby preferably mounted on the input side of the multiplication elements or directly on the motor, where even when there are small actuating movements by the actuators, the distance traveled by the positional sensor is long enough to ensure precise determination of the position. The path markers or the stationary stops are usually located on the output side of the multiplication element so that the actuator can directly move into these positions within the range of movement. Incremental or absolute sensors are available for measuring where the latter are preferably used due to their simpler design.

Because incremental sensors no longer detect the absolute position of the actuator after a breakdown has occurred or the power supply has been shut off and because incremental and absolute sensors are, under some circumstances, unable to detect dynamic or static influences on the multiplication element, an alignment of the positional sensor with a fixed path marker is necessary. For this purpose, the actuator moves toward a path marker having a known position, detects the marker by way of a marker sensor, and subsequently references the positional sensor to the path marker position. It is important that the marker sensor detects the path marker as accurately as possible at the exact position thereof, which is why the detection region of the marker sensor must be as small as possible and exactly aligned.

DE 10 2004 057 341 A1 describes a device for adjusting an actuator in an electromechanically adjustable vehicle stabilizer by way of a fixed path marker. The actuator substantially comprises two components that can be actively rotated in relation to each other, and one angle sensor, as well as a path marker provided on the first component, and a marker sensor situated on the second component. To this end, in the neutral position of the components, which is to say the position in which they rotate uniformly in relation to each other during operation, the marker sensor and the path marker are aligned with one another such that the path marker is exactly in the middle of the detection region of the marker sensor. However, as the exact position of the path marker, inside the detection region, cannot be exactly determined, the two components are rotated in relation to one another immediately after startup such that the marker sensor moves toward the path marker from both directions of rotation, whereby the angle sensor determines the current position of the component as the path marker is detected. On the basis of these two positions, a mean-value position is determined, which is assumed to be the neutral position, whereupon the positional sensors can be adjusted to this position.

In the state of the art, it is assumed that the path marker in the neutral position is exactly in the middle of the detection region of the marker sensor and that the detection region of the marker sensor is symmetrically designed. In this way, the components that can be rotated in relation to each other, the marker sensor and the angle sensor must meet very high qualitative requirements and is exactly aligned with each other.

The invention is therefore based on the task of creating a device and a method where the location of the neutral position of an actuator, preferably an actuator for adjusting an adjustable vehicle stabilizer, can be most accurately determined, without the components of the device having to meet very high quality requirements.

### SUMMARY OF THE INVENTION

A device for determining a neutral position of two components that can be moved in relation to each other comprises an adjustment device for moving the components into an arbitrary relative position and a positional sensor for detecting the relative positions, as well as a path marker located on the first component, and a marker sensor located on the second component to detect the path marker inside a detection region. The neutral position thereby corresponds to the position of the components around which they move uniformly during operation. It is characteristic of the invention that in the neutral position, the detection region of the marker sensor and the path marker are aligned with each other in such a way that the path marker is located at a known distance outside the detection region, and a data processing installation is connected to the marker sensor and the positional sensor, wherein the installation can add the known distance between the detection region of the marker sensor and the path marker to a relative position detected by the positional sensor. The distance is thereby measured in such a way that during operation, the path marker passes the marker sensor as often as possible and is detected by the latter, whereby the distance is determined before installation of the device in the final installation position thereof, for example in a test state, and can later be permanently stored in the data processing installation.

In an advantageous embodiment of the invention, the two components each form one half of a vehicle stabilizer that can be adjusted by way of an actuator and, in the neutral position, have the function of a fixed guide or the two components are elements of an actuator for adjusting the wheel rotation plane of a vehicle.

Particularly advantageous are sensors that detect the path marker or the relative position of the components in a touchless manner by way of magnetic, electrical or optical effects, for example by way of a light barrier or a Hall sensor.

In one embodiment of the invention, the path marker is formed by the transition between two marking regions arranged one after the other in the direction of movement, wherein the marker sensor can detect and distinguish between the marking regions within the detection region. It is thereby advantageous for the marking regions to form two levels of different heights, and the path marker is made of a step between the two levels that runs perpendicular to the direction of movement.

In an advantageous embodiment of the invention, the two components are arranged co-axially and configured rotatably around the longitudinal axis or displaceably along the longitudinal axis, whereby the path marker is provided on the internal component and the marker sensor on the external component. Here, no rotatable or displaceable connecting lines to the marker sensor are required. Therefore, the inventive device can be used for detecting the neutral position of tie rods in vehicle steering assemblies, or of push rods in motor vehicle transmissions.

An additional highly advantageous embodiment of the invention provides for a data memory which, during operation, can store a plurality of relative positions or neutral positions detected by the positional sensor or the data processing installation. Using the data memory, it is therefore possible for the data processing installation to detect an average neutral position that is obviously closer to the actual neutral position than a singular determination of the neutral position that is strongly dependent on the detection tolerances of the positional and marker sensors.

According to the method, the positional sensor, when detecting the path marker by way of the marker sensor, determines the relative position of the components to each other and the data processing installation, using this information and the known distance between the detection region of the marker sensor and the path marker, then calculates the neutral position of the components.

During the operation of the inventive device, for example when the device is employed in an actively adjustable electromagnetic vehicle stabilizer, the components of the device are frequently displaced relative to each other around the neutral position by way of the adjustment device or external influences, whereby the path marker often passes the marker sensor. In a particularly advantageous inventive method, a data memory stores the relative position of the components at a point in time when the marker sensor detects the path marker. Then, based on all the stored relative positions, the data processing installation calculates a considerably more accurate average relative position which, in turn, is used to determine the neutral position, using the known distance between the detection region of the marker sensor and the path marker. Alternatively, with every identification of the path marker, the data processing installation can also first determine the neutral position using the relative position detected by the positional sensor. The neutral position being stored in the data memory and, on the basis of which the data processing installation calculates a new average neutral position during the storing process. Because this takes place during the ongoing operation of the device, the average neutral position is continuously updated and accurately adjusted to the neutral position using the statistical mean value. As a mean value, the arithmetic mean value or the modal value can be calculated. According to the invention, the data memory can have both a volatile and a non-volatile memory.

If no neutral position is determined by the data processing installation after the inventive device has been started, an additional embodiment of the invention provides for the components to be rotated into arbitrary positions relative to each other, using the adjustment device, until the marker sensor detects the path marker. Then the data processing installation determines the neutral position using the relative position of the components that is hereby detected by the positional sensor, as well as the known distance between the path marker and the detection region of the marker sensor. In a refinement thereof the path marker is formed by the transition between the marking regions that are arranged one after the other in the direction of movement. This makes it possible, on the basis of the marking region that is presently detected by the marker sensor, to infer the direction of movement in which the two components must be moved, relative to each other, in order for the path marker to pass the marker sensor.

### BRIEF DESCRIPTION OF THE DRAWINGS

The invention will now be described, by way of example, with reference to the accompanying drawings in which:

FIG. 1 shows two co-axially oriented components in a neutral position, which can be displaced relative to each other in a longitudinal direction, wherein a positional sensor detects the displaced segment and a step-like path marker is provided on the first component, the marker being recognizable by a marker sensor provided on the second component, and

FIG. 2 shows two co-axially oriented components in a neutral position, which can be rotated relative to each other, wherein a positional sensor determines the angle of rotation and, on the circumference of the first component, a step-like path marker is provided, which can be detected by a marker sensor provided on the second component.

### DETAILED DESCRIPTION OF THE INVENTION

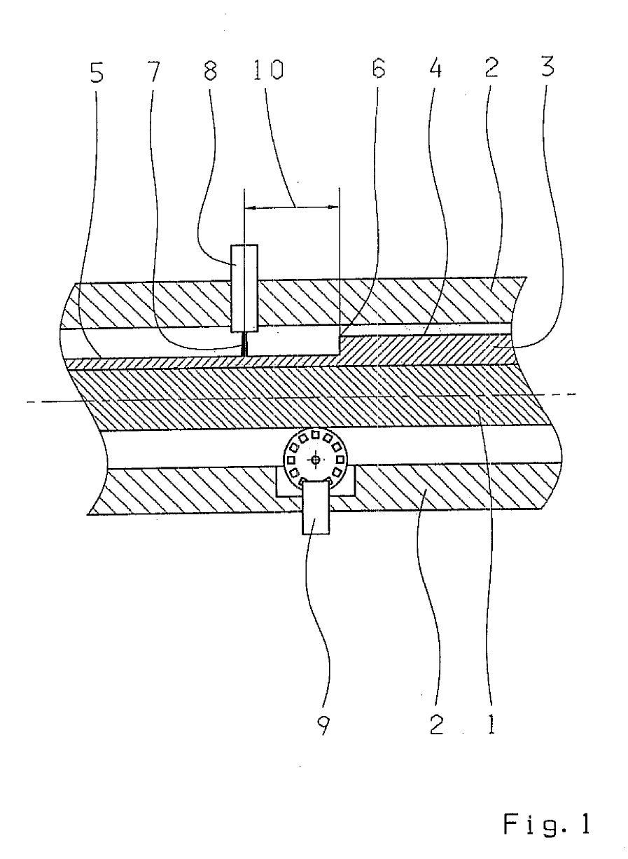

In FIG. 1, the inventive device is shown in the neutral position. A first component 1 is hereby arranged co-axially in a second component 2 and displaceably in the longitudinal direction, wherein a marker bar 3 is fixed on the first component 1 in a stationary manner. The bar is divided into different heights in the marking regions 4, 5. The transition, between the marking regions 4, 5, forms the path marker 6, the transition being graduated perpendicular to the direction of movement. In the depicted neutral position of the components, a detection region 7 of the marker sensor 8, which is fixed on the second component 2 in a stationary manner, is situated at a known distance 10 from the path marker 6. Due to the different shapes of the marking regions 4, 5, which the marker sensor 8 can detect and distinguish, the direction of movement is known in which the adjustment device (not shown), must displace the components 1, 2 in relation to each other so that after the inventive device has been started up, the path marker 6 passes the marker sensor 8. In the example shown, the marker sensor 8 recognizes the wide gap between the first marking region 5 and the second component 2, where it is known that the first component 1 must be displaced in the direction of the left side of the second component 2 so that the path marker 6 passes the marker sensor 8. A positional sensor 9, which is configured as an incremental sensor, thereby determines the distance traveled between the components 1, 2. The positional sensor 9 and the marker sensor 8 are connected to the data processing installation (not shown), and which can calculate the neutral position using the relative position detected by the positional sensor 9 and the known distance 10 between the detection region 7 and the path marker 6. The data processing installation preferably has a data memory that stores the relative positions detected by the positional sensor 9 during recognition of the path marker 6 and, on the basis of the relative positions, the data processing installation can determine an average position.

According to the invention, the device can determine the neutral position of the two components by way of the method explained below. Before the inventive device is started up for the first time, it is necessary to determine the distance 10 between the detection region 7 of the marker sensor 8 and the path marker 6, for which purpose the components 1, 2 are moved several times relative to each other in a test best such that the path marker 6 passes the marker sensor 8 from different directions of movement and is recognized by the sensor. The positional sensor 9 hereby determines, based in each instance on the neutral position, the changes in the position undergone by the components until the detection of the path marker 6; the changes of position then being combined into an average change of position. This is subsequently considered the fixed distance 10 between the detection area 7 of the marker sensor 8 and the path marker 6 and is stored in the data processing installation for future determination of the neutral position.

After the positioning of the inventive device in the final installation position thereof or, as the case may be, after each startup, no neutral position has yet been determined by the data processing installation, which is to say there is still the previously determined distance 10 between the detection region 7 of the marker sensor 8 and the path marker 6, however the position that the components 1, 2 currently assume in relation to each other, and where their neutral position is located are unknown. The data processing installation therefore prompts the adjustment device to displace the components 1, 2 in such a manner that the path marker 6 passes the marker sensor 8, whereby the direction of movement is dependent on the marking regions 4, 5 recognized in the detection region 7. As soon as the marker sensor 8 recognizes the path marker 6, the data processing installation calculates the neutral position on the basis of the relative position of the components 1, 2 detected by the positional sensor 9 at this point in time, and the known distance 10. Preferably, subsequently an adjustment of the positional sensor 9 to the neutral position is performed, whereupon the sensor can be used as the absolute sensor.

During operation, due to external influences or the adjustment device, the components 1, 2 are constantly moved relative to each other around the neutral position. Because the distance 10 between the detection region 7 of the marker sensor 8 and the path marker 6 is designed as very small, the path marker 6 passes the marker sensor 8 frequently, and each time the path marker 6 is detected, the data memory stores the relative position thereby detected by the positional sensor 9. Each time information is stored, the data processing installation determines an updated average relative position on the basis of all the stored relative positions, on the basis of which average position it then determines a more accurate neutral position, taking into account the known distance 10. Then preferably a new adjustment of the positional sensor 9 is performed to the more accurate neutral position. Because a very accurate determination of the distance 10 between the detection region 7 of the marker sensor 8 and the path marker 6 is possible before startup, for example during on a test bench, and because during operation the position of the path marker 6 can be accurately determined via the statistical averaging of the detected relative positions, the position tolerances between the path marker 6 and the marker sensor 8, as well as the detection region 7 of the marker sensor 8, can be expanded, which makes the production of the device simpler and more cost-efficient. In addition, the detection region of the marker sensor does not have to be symmetrical.

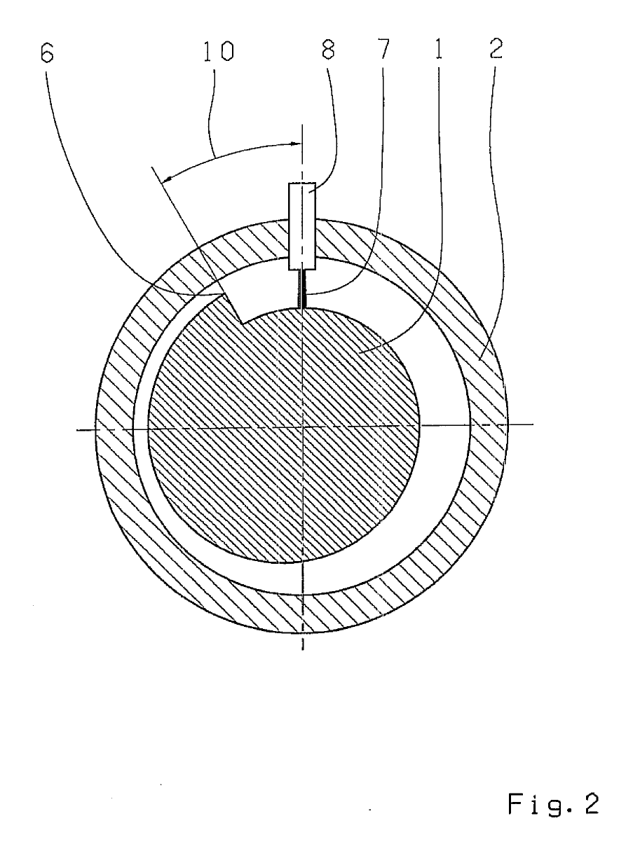

FIG. 2 shows an additional embodiment of the invention, wherein the first component 1 is arranged co-axially and rotatably around the longitudinal axis inside the second component 2, and a gap is provided between the components 1, 2. In the depicted neutral position, the detection region 7 of the marker sensor 8 is disposed at a distance by the known angle 10 from the path marker 6, which is configured in a step-like manner perpendicular to the direction of rotation, where the angle of rotation is detected by an angle sensor, which is not depicted, acting as a positional sensor. Also not shown is the adjustment device that brings about the rotation of the components. During rotation, the marker sensor 8 emits an output signal that is equivalent to the gap width. The signal is checked by the data processing installation for fluctuations. These always occur when the detection region 7 of the marker sensor 8 passes the path marker 6. In order to reliably detect the neutral position during a rotation of more than 360° by the components 1, 2, it is useful to provide the positional sensor with a counting device or to configure the positional sensor as a multi-turn sensor. It can also be practical to divide the circumference of the first component 1, similar to the example shown in FIG. 1, into two separate marking regions, whereby the direction of rotation can be determined in which the components 1, 2 must be rotated after startup in order to detect the path marker 6. However then, during operation, only a maximum angle of rotation of less than 180° is practical.

### REFERENCE NUMERALS

1 component
2 component
3 marker bar
4 marking region
5 marking region
6 path marker
7 detection region
8 marker sensor
9 positional sensor distance between the detection region 7 of the marker sensor 8 and the path marker 6 in the neutral position of the components 1, 2

1-12. (canceled)

13. A determination device for determining a neutral position of first and second components that are displaceable relative to one another (1, 2) by way of a actuator, the first and the second components, in the neutral position, functioning as a stationary guide, the determination device comprising an adjustment device for moving the first and the second components (1, 2) into an arbitrary relative position, and a positional sensor (19) for determining the relative position of the first and the second components (1, 2), a path marker (6) located on the first component (1) and a marker sensor (8) provided on the second component (9) for detecting the path marker (6) in a detection region (7), the first and the second components (1, 2) are aligned in the neutral position with respect to each other that the path marker (6) is arranged outside the detection region (7) of the marker sensor (8), a distance (10) between the detection region (7) and the path marker (6) is known, and a data processing installation that is connected to the marker sensor (8) and the positional sensor (9), the data processing installation determining the neutral position of the first and the second components (1, 2) during detection of the path marker (6) by the marker sensor (8) using the relative position determined by the positional sensor (9) and the known distance (10) between the detection region (7) of the marker sensor (8) and the path marker (6).

14. The determination device for determining a neutral position according to claim 13, wherein the path marker (6) comprises a transition between two marking regions (4, 5) arranged adjacently one after the other in a direction of movement of the first and the second components (1, 2), and that the marker sensor (8) identifies and distinguishes between the two marking regions (4, 5) in the detection region (7).

15. The determination device for determining a neutral position according to claim 14, wherein the two marking regions (4, 5) are two levels of different heights, and the path marker (6) forms a perpendicular step between the two levels in the direction of movement.

16. The determination device for determining a neutral position according to claim 14, wherein the marker sensor (8) is linked to the adjustment device such that the adjustment device can displace the first and the second components (1, 2), depending on a currently recognized one of the two marking regions (4, 5), in a prescribed direction in relation to each other.

17. The determination device for determining a neutral position according to claim 13, wherein the marker sensor (8) detects the path marker (6) one of optically, electrically and magnetically.

18. The device for determining a neutral position according to claim 13, wherein the first and the second components (1, 2) are co-axial and one of rotatable and displaceable in relation to each other.

19. The device for determining a neutral position according to claim 13, wherein the data processing installation has a data memory which, each time the path marker (6) is detected, stores the relative position determined by one of the positional sensor (9) and the neutral position calculated by the data processing installation, and the data processing installation calculates an average position based on the relative positions stored in the data memory.

20. A method of determining a neutral position of first and second components, that are displaceable, relative to one another (1, 2) by way of an actuator, with a determination device, the first and the second components, in the neutral position, functioning as a stationary guide, the determination device comprising an adjustment device for moving the first and the second components (1, 2) into an arbitrary relative position, and a positional sensor (9) for determining the relative position of the first and the second components (1, 2), a path marker (6) being located on the first component (1) and a marker sensor (8) being provided on the second component (2) for detecting the path marker (6) in a detection region (7), the first and the second components (1, 2) being aligned in the neutral position with respect to each other that the path marker (6) is arranged outside the detection region (7) of the marker sensor (8), a distance (10) between the detection region (7) and the path marker (6) is known, and a data processing installation that is connected to the marker sensor (8) and the positional sensor (9), the method comprising the steps of:
moving the first and the second components (1, 2) to the arbitrary relative position with the adjustment device;
repeatedly detecting the path marker (6) with the marker sensor (8) as the first and the second components (1, 2) move relative to each other;
determining the relative position of the first and the second components (1, 2) with the positional sensor (9) each time the path marker (6) is detected with the marker sensor (8); and
determining the neutral position of the first and the second components (1, 2) with the data processing installation based on the relative position detected by the positional sensor (9) and the known distance (10) between the detection region (7) of the marker sensor (8) and the path marker (6).

21. The method of determining a neutral position of the first and the second components (1, 2) according to method of claim 20, further comprising the step of storing the neutral position determined by the data processing installation in a data memory, and determining an average neutral position based on a plurality of the stored neutral positions with the data processing installation.

22. The method of determining a neutral position of the first and the second components (1, 2) according to claim 20, further comprising the steps of
storing the relative position determined by the positional sensor (9) in a data memory each time the path marker (6) is detected by the marker sensor (8);
determining an average relative position with the data processing installation based on the stored relative positions; and
determining the neutral position based on the average relative position and the known distance (10) between the detection region (7) of the marker sensor (8) and the path marker (6).

23. The method of determining a neutral position of the first and the second components (1, 2) according to claim 20, further comprising the step of moving the first and the second components (1, 2) in a direction of movement with the adjustment device after every startup of the determination device in relation to each other until the path marker (6) is detected by the marker sensor (8).

24. The method of determining a neutral position of the first and the second components (1, 2) according to claim 23, further comprising the step of defining the direction of movement, in which the adjustment device moves the first and the second components (1, 2) in relation to each other, based on a marking region (4, 5) detected by the marker sensor (8).

25. A determination device for determining a neutral position of first and second halves of a vehicle stabilizer, the determination device comprising:
an actuator which communicates with the first and the second halves (1, 2) of the vehicle stabilizer for biasing the first and the second halves (1, 2) of the vehicle stabilizer relative to one another;
a position sensor (9) being fixed to one of the first and the second halves (1, 2) of the vehicle stabilizer and monitoring relative movement between the first and the second halves (1, 2) of the vehicle stabilizer for determining a relative position of the first and the second halves (1, 2) of the vehicle stabilizer relative to one another;
a position marker (6) being located on the first half (1) of the vehicle stabilizer;
a marker sensor (8) being located on the second half (2) of the vehicle stabilizer and detecting the position marker (6) as the position marker (6) is conveyed past a detection region (7) of the marker sensor (8) when the first and the second halves (1, 2) of the vehicle stabilizer move relative to one another;
the position marker (6) being separated by a known distance (10) from the detection region (7) of the marker sensor (8) when the first and the second halves (1, 2) of the vehicle stabilizer are in the neutral position; and
a data processing installation being connected to the marker sensor (8) and the position sensor (9), for receiving data regarding the relative position of the first and the second halves (1, 2) of the vehicle stabilizer such that, with the known distance (10) between the position marker (6) and the detection region (7) of the marker sensor (8) and the data regarding the relative position of the first and the second halves (1, 2), the data processing installation determines the neutral position when the marker sensor (8) detects the position marker (6).
